(19) United States
(12) Patent Application Publication
(10) Pub. No.: US 2004/0109170 A1
(43) Pub. Date: Jun. 10, 2004

(54) Confocal distance sensor

(76) Inventor: Anton Schick, Velden (DE)

Correspondence Address: HARNESS, DICKEY & PIERCE, P.L.C., P.O.BOX 8910, RESTON, VA, 20195, US

(21) Appl. No.: 10/660,540

(22) Filed: Sep. 12, 2003

(30) Foreign Application Priority Data
Sep. 12, 2002 (DE) 10242374.1

(51) Int. Cl. G01B 11/14

(52) U.S. Cl. 356/614

(57) ABSTRACT

A sensor is for rapid optical distance measurement based on the confocal imaging principle. The sensor includes a light source, which emits an illuminating light with different spectral components, and an optical imaging system, through which the illuminating light is directed onto the surface of a measurement object. Different spectral components of the illuminating light are focused at different distances from the optical imaging system due to a chromatic aberration of the optical imaging system. Also provided are a beam splitter, arranged so that measuring light reflected back at least partially from the surface, is separated spatially from the beam path of the illuminating light. Further, a light receiver is included, which records the measuring light, separated spatially from the beam path of the illuminating light, with spectral resolution. Finally, an analysis unit determines the distance between the sensor and the surface from the intensities of measuring light recorded for different spectral components.

The present application hereby claims priority under 35 U.S.C. §119 on German patent application number DE 10242374.1 filed Sep. 12, 2002, the entire contents of which are hereby incorporated herein by reference.

1. Field of the Invention

The invention generally relates to a sensor for rapid optical distance measurement based on the principle of confocal imaging.

2. Background of the Invention

The constantly increasing integration density on electronic assemblies indicates an increasing number of connections for electronic components. To keep up with this trend, assembly and contact methods have been developed, with which the components make contact with connecting surfaces on a substrate to be fitted by solder balls on the undersides of the components. Such components are, for example, what are known as ball grid arrays (BGA) or flip chips. To ensure reliable contact, the connections have to be inspected accurately before components are fitted. This is because, faulty connections, which result in a poor electrical contact between the component and the connection surfaces, can no longer be detected after fitting.

In order to be able to produce high quality electronic assemblies at low cost, modern inspection systems for electrical components are subject to a large number of requirements. For example, the inspection system must be able to determine the parameters of the object of the inspection, such as its dimensions, the coplanarity of the electrical connections or the distribution of the connections. It should also be possible to carry out the inspection within as short a test period as possible, incurring a low level of cost and operating in a contactless manner. These stringent requirements for measuring three-dimensional surfaces can generally only be met by optical methods for measuring surface profiles. Runtime methods, triangulation methods and confocal methods are known optical inspection methods in such a context.

Runtime methods, with which the distance between the sensor and the surface to be measured is determined from the runtime of a light pulse reflected back from the surface, in a broader context, also include what are known as interferometric methods. These, can achieve very high spatial resolution by superimposing coherent light beams. The interference signal is generated by mechanical movement of an optical element in an interferometer or a change in the optical path length within an interferometer. Relatively long measurement times are required here, in particular for superficial image acquisition of a surface to be measured.

Triangulation methods include all methods, with which the illumination or projection direction differs from the observation direction. Methods which operate by way of structured illumination (e.g. moiré methods), are also included, as the deformation of the template projected onto the surface to be recorded, from which deformation the height of individual points is calculated, can only be observed at a specific triangulation angle. Measurement of three-dimensional surface profiles by way of structured illumination ideally requires object surfaces with isotropic scatter, as surfaces with anisotropic scatter, i.e. at least slightly reflective surfaces, cannot reflect the deformation of the structured illumination by the three-dimensional surface due to a specular lens effect. As the reliability of the measurement results depends very much on the reflective behavior of the surface to be measured, a solder ball inspection using structured illumination is generally impossible or extremely problematic.

Triangulation methods also include what are known as laser triangulation methods, with which the surface to be measured is scanned with a laser beam and the point of contact of the laser beam is recorded by camera. Rapid deflection units, such as rotating polygonal mirrors or galvanometer scanners are used here to deflect the laser beam in a defined manner. Alternatively a relative movement can be generated between the object and the laser beam by moving the object to be measured. Measurements using laser triangulation have the disadvantage that a large number of surface points cannot be scanned simultaneously, only one after the other in time, so that the resulting test times are correspondingly long.

Confocal optical methods for measuring three-dimensional surfaces are characterized by high resolution and by a high level of robustness in respect of scattered light generated by secondary reflections. Confocal optical methods also have the advantage that surfaces can be measured coaxially, so that shadowing problems due to illuminating light hitting the surface obliquely or due to an angle of observation which is too oblique in respect of the surface do not occur. Confocal microscopy, which has been known for a long time now, therefore represents a very precise but slow method of three-dimensional surface measurement. Conventional confocal distance sensors also have the disadvantage that periodic relative movement is required between the sensor and the surface to be measured, so the scan speed is also limited due to the mass inertia of the masses to be moved.

A modified confocal sensor for three-dimensional surface measurement is known from EP 835423 B1, with which swift surface measurement is possible due to rapid focal movement, achieved by way of a mechanically displaced retroreflector using a linear arrangement of a plurality of laser beams. Image acquisition here is comparable to a line camera, by which in principle infinite images can be acquired by moving the object to be measured and/or the camera in a direction perpendicular to the camera line. For this reason the modified confocal sensor is also suitable for measuring larger objects such as wafers or substrates. As the image width is determined by the length of the scanned line, larger image areas have to be measured by meandering scanning of the surface. The modified confocal sensor has the disadvantage that the focal movement required is generated by displacement of the retroreflector so that even though a smaller mass has to be displaced than with conventional confocal distance sensors, the mass inertia of the displaced retroreflector still limits the scan speed.

### SUMMARY OF THE INVENTION

An object of an embodiment of the invention is therefore to create a sensor for rapid optical distance measurement based on the confocal imaging principle, which requires neither relative movement between the sensor and the surface to be measured nor mechanical displacement of an optical component of the sensor in order to determine the distance between the sensor and a surface point.

An object may be achieved by way of a sensor for rapid optical distance measurement based on the confocal imaging principal. An embodiment of the invention is based on the recognition that chromatic aberration, which generally constitutes an unwanted imaging error in a dispersive optical imaging system and is therefore corrected in most lens systems, can be used advantageously for a confocal distance sensor.

The fact that chromatic aberration indicates that different spectral components of a light beam focus at different distances from the optical imaging systems, is used according to an embodiment of the invention so that the spectral distribution of a measuring light which is reflected back at least partially from the surface and is recorded, after a repeat pass by the optical imaging system, by a light receiver with spectral resolution, is a measure of the distance between the sensor and the surface. The light receiver here is arranged in a confocal manner in respect to the light source emitting the illuminating light. In other words, the different spectral components of the illuminating light are spatially split by the chromatic aberration of the optical imaging system in such a way that the focal points for different spectral components are above each other in the object area.

If there is then an object in the object area, the spectral component, which strikes the surface to be measured with the smallest possible focus, is preferably projected onto the light receiver. Thus, the confocal condition is preferably satisfied for one spectral color only. The color of the light detected with the greatest intensity is therefore a measure of the distance between the sensor according to an embodiment of the invention and the focal point on the surface of the object.

The height measurement range of the sensor is determined by the strength of the chromatic aberration of the optical imaging system, with the option of using preferably known chromatic error-correction lenses or lens systems. The confocal distance sensor according to an embodiment of the invention therefore allows distance to be determined with a single color image acquisition, advantageously requiring neither movement of an optical component of the sensor nor relative movement between the sensor as a whole and the measurement object. The resolution of the confocal distance sensor is deter-mined by the numerical aperture of the optical imaging system, the strength of the chromatic aberration of the optical imaging system and by the spectral resolution power of the light receiver.

The sensor according to an embodiment of the invention is particularly suitable for measurement objects, which reflect the illuminating light in a manner which is almost color-neutral, as in this case it is possible to determine distance without color calibration. Such color-neutral reflections frequently occur with metals or alloys, which are generally used as electrical connection materials between electronic components and substrates. For this reason the sensor according to the invention can be used in particular for inspections in the electronics field, as in this field, as described above, conventional optical inspection methods are frequently subject to a high level of inaccuracy.

According to an embodiment, the measuring light may be fed via the optical imaging system, so that the height resolution of the sensor is directly proportional to the square of the numerical aperture NA. The sensor can also be constructed with a particularly compact structure.

According to an embodiment, the light source may be a white light source, which provides a broad spectral distribution of the illuminating light particularly easily.

The use of a color camera as the light receiver according to an embodiment, has the advantage that no additional optical resolution elements, such as for example lattices or prisms are required, as spectral resolution of the measuring light is effected directly by the light receiver.

In another embodiment, the illuminating light from a specific point light source strikes a specific surface point and from this specific surface point strikes a specific point detector arranged in a confocal manner in respect of the point light source and assigned to the point light source, is such that a large number of surface points can be measured at the same time. In this way a complete three-dimensional surface profile of a measurement object can be recorded using a single color image acquisition with a corresponding number of point light sources and point detectors.

The development according to an embodiment allows a plurality of light sources and light receivers to be set up in a particularly simple manner. A plurality of light sources can be generated here by arranging a corresponding grating system with a plurality of diffraction gratings in front of a two-dimensional light source. The plurality of point detectors can best be achieved using a local resolution surface detector, which is arranged behind a corresponding grating system with a plurality of diffraction gratings.

The use of a micro-lens arrangement according to an embodiment has the advantage of increasing the luminous efficiency of the diffraction gratings system. This also increases the intensity of the measuring light striking the light receiver. A further advantage of using a micro-lens arrangement results when the micro-lens arrangement is structured so that the light is directed to focus on the gratings, thereby reducing unwanted scatter effects. In this case precisely one lens element of the micro-lens ar-rangement is associated with each diffraction grating.

The use of an intermediate image of the light source according to an embodiment -has the advantage that the sensor at the same time constitutes a confocal microscope with a high level of lateral resolution. There are at least two options for the arrangement of the further optical imaging system within the sen-sor.

The further optical imaging system may be located in the joint beam path of the illuminating light and the measuring light between the optical imaging system and the beam splitter. Also, the further optical imaging system may be located only in the beam path of the illuminating light between the light source and the beam splitter. In this case a further optical imaging system is preferably used which is located solely in the beam path of the measuring light between the beam splitter and the light receiver.

According to an embodiment, a grating system is located in the area of the intermediate image, so that the confocal condition is advantageously satisfied regardless of the precise arrangement of the light source and the light receiver.

The use of a rotating Nipkow disk according to an embodiment allows sequential scanning of the surface to be measured by way of a single color image acquisition, which is illuminated for a certain period.

The use of a stationary diffraction grating matrix according to an embodiment in conjunction with a surface detector with local resolution corresponding to the diffraction grating matrix has the advantage that a plurality of surface points on the measurement object can be scanned at the same time. A CCD line or a CCD camera is particularly suitable as a surface detector.

### BRIEF DESCRIPTION OF THE DRAWINGS

Further advantages and features of the present invention are set out in the description of examples of currently preferred embodiments below, including the drawings wherein:-.

FIG. 1 shows a single-channel confocal optical distance sensor.

FIG. 2 shows a multi-channel confocal optical distance sensor.

### DETAILED DESCRIPTION OF THE PREFERRED EMBODIMENTS

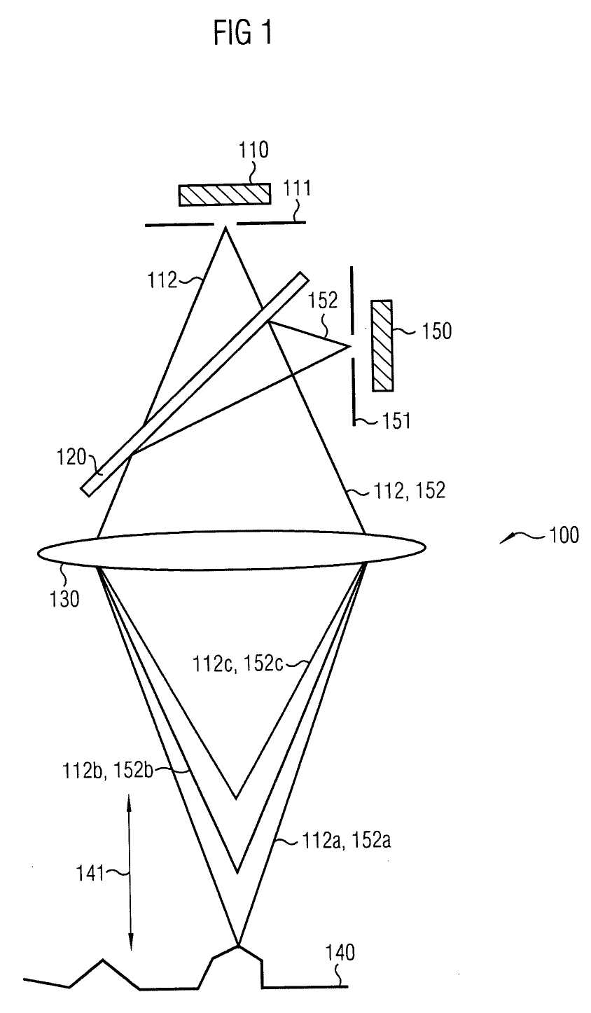

The single-channel confocal distance sensor 100 shown in FIG. 1 has a light source 110, which together with a diffraction grating 111 constitutes what is known as a point light source. This emits an approximately white light beam 112, which, after transmission through a beam splitter 120, strikes an optical imaging system 130, which has a high level of chromatic aberration due to a known chromatic error correction. The optical imaging system 130 splits the light beam 112 into different spectral components, of which a red spectral component 112a, a green spectral component 112b and a blue spectral component 112c are shown schematically in FIG. 1.

The focal points of these different spectral components 112a, 112b, 112c define a height measurement range 141. Different sized surface areas are illuminated on the surface 140 of a measurement object as a result based on the spectral color of the light beam 112. As a result, the light density, which generates a measuring beam 152 going out from the surface 140 with a red spectral component 152a, a green spectral component 152b and a blue spectral component 152c, differs in strength for each spectral color.

The measuring beam 152, which is generated by at least partial reflection of the light beam 112 off the surface to be measured 140, is projected by the optical imaging system 130 into a point detector, with the measuring beam 152 being reflected off the beam splitter 120 between the optical imaging system 130 and the point detector. According to the embodiment disclosed here, the point detector is provided by a color detector 150, which is arranged behind a diffraction grating 151. Depending on the height of the surface to be measured 140, the confocal condition is only satisfied between the point light source or the point detector and the surface for one spectral color, which makes up the largest proportion with distance of the total intensity recorded by the point detector. In this way the color of the light detected by the point detector is a measure of the distance between the distance sensor 100 and the surface of the measurement object.

It should be pointed out that with the distance sensor 100 shown in FIG. 1 the position of the point light source can be interchanged with the position of the point detector. In this case the illuminating light strikes the optical imaging system 130 after being reflected off the beam splitter 120 and the measuring light reaches the point detector after transmission through the beam splitter 120.

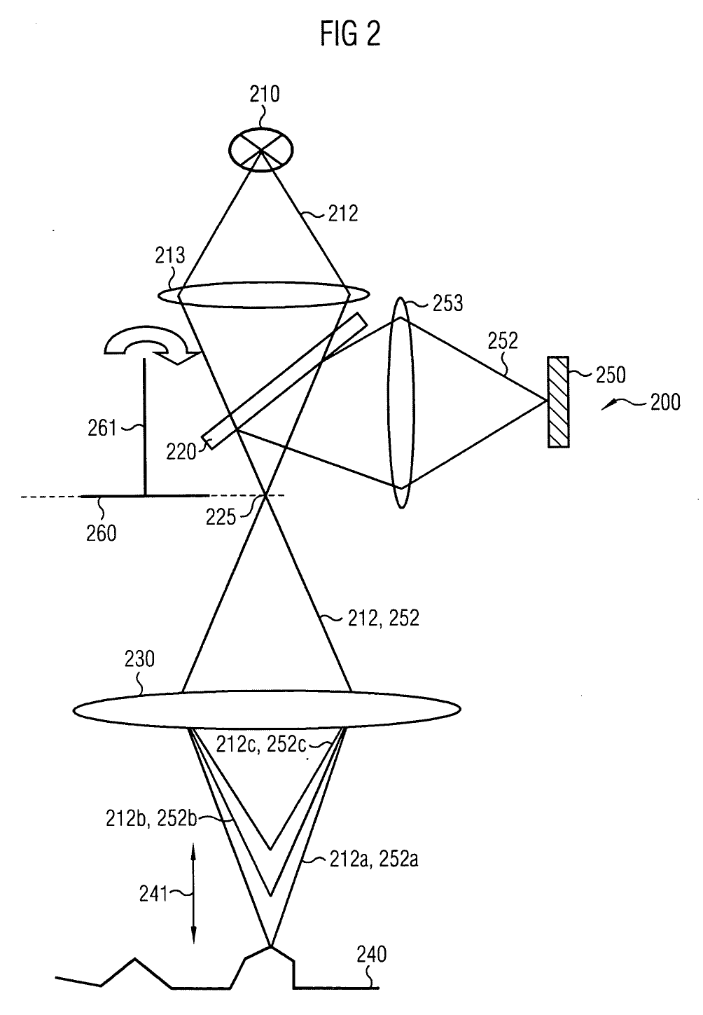

FIG. 2 shows a multi-channel distance sensor 200 according to a second embodiment of the invention. The distance sensor 200 has a two-dimensional light source 210, which emits a white illuminating light with a broad spectral bandwidth. For reasons of clarity, of the plurality of light beams emitted by the two-dimensional light source 210 only one light beam 212 originating from a single two-dimensional element of the light source 210 is shown. The light beam 212 is deflected by an optical imaging system 230, which preferably has a slight chromatic aberration, so that after transmission through a beam splitter 220 an intermediate image 225 of the surface element of the light source 210 is generated.

In the plane of the intermediate image 225 is a Nipkow disk 260, which rotates about an axis of rotation 261. In this way the Nipkow disk 260 generates a plurality of point light sources sequentially at a distance from each other in the plane of the intermediate image 225. The point light sources generates by the Nipkow disk 260 are projected via the optical imaging system 230, which is known to have a high level of chromatic aberration, onto the surface to be measured 240. The optical imaging system 130 splits the light beam 212 into different spectral components, of which a red spectral component 212a, a green spectral component 212b and a blue spectral component 212c are shown schematically in FIG. 2.

The focal points of these different spectral components 212a, 212b, 212c define a height measurement range 241. As a result different sized surface areas are illuminated on the surface 240 of a measurement object, depending on the spectral color of the light beam 212. The bigger the illumination surface on the surface 240, the lower the light density of the surface area in question, which generates a measuring beam 252 due to at least partial scattering back of the light beam 212.

The surface areas of the surface 240 illuminated to a varying degree by the light beam 212 are projected via the optical imaging system 230 into the plane of the intermediate image 225. The spectral color, which illuminates the smallest possible area on the surface 240, has the greatest light intensity with distance. The measuring beam 252a reflected from the surface 240 with the greatest intensity then passes through the same hole in the Nipkow disk 260 as ensured the illumination of the surface 240 beforehand. The light passing through the Nipkow disk 260 is reflected off the beam splitter 220 and projected via an optical imaging system 253 onto a two-dimensional color detector 250. In this way the hole in the Nipkow disk 260 also acts as a point detector, which is automatically arranged in a confocal manner in respect of the point light source. The spectral component of the measuring beam 252, which has the strongest intensity, is therefore a direct measure of the distance between the distance sensor 200 and the illuminated surface point on the surface 240. The Nipkow disk 260 therefore advantageously allows sequential scanning of the surface 240, with a plurality of surface points being scanned at the same time with each individual scanning process.

It should be pointed out that a grating system with diffraction gratings arranged in matrices can be used instead of a rotating Nipkow disk, with the lattice of the diffraction gratings being adjusted to the local resolution of the color camera. In this case the surface to be measured is measured not sequentially but at a plurality of surface points at the same time.

To summarize, at least one embodiment of the invention provides a sensor for rapid optical distance measurement based on the confocal imaging principle. The sensor includes a light source 210, which emits an illuminating light 212 with different spectral components, and an optical imaging system 230, through which the illuminating light 212 is directed onto the surface 240 of a measurement object, with different spectral components of the illuminating light 212 being focused at different distances from the optical imaging system 230 due to a chromatic aberration of the optical imaging system 230. Also provided are a beam splitter 220, which is arranged so that the measuring light 252, which is reflected back at least partially from the surface 240, is separated spatially from the beam path of the illuminating light 212, a light receiver 250. The light receiver 250, detects the measuring light 252, which is separated spatially from the beam path of the illuminating light 212, with spectral resolution. It further includes an analysis unit, which determines the distance between the sensor 200 and the surface 240 from the intensities of measuring light 252 detected for different spectral components.

A multi-channel distance sensor, with which each of a plurality of surface points can be measured sequentially, can be provided by using a rotating Nipkow disk 260, which is arranged in an intermediate image 225 of a two-dimensional light source 210 between the optical imaging system 230 and a further optical imaging system 230 generating the intermediate image 225. A multi-channel distance sensor, with which a plurality of surface points can be measured at the same time, can preferably be generated by an arrangement of different diffraction gratings, each of which is associated with one color detector from a plurality of color detectors or one surface element of a local resolution color detector.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A sensor for rapid optical distance measurement based on a confocal imaging principle, comprising:
a light source, adapted to emit an illuminating light with different spectral components;
an optical imaging system, adapted to direct the illuminating light onto a surface of a measurement object, wherein different spectral components of the illuminating light are adapted to be focused at different distances from the optical imaging system due to a chromatic aberration of the optical imaging system;
a beam splitter, arranged so that the measuring light, reflected back at least partially from the surface, is adapted to be separated spatially from the beam path of the illuminating light;
a light receiver, adapted to detect the measuring light separated spatially from the beam path of the illuminating light with spectral resolution; and
an analysis unit, adapted to determine the distance between the sensor and the surface from the intensities of the measuring light detected for different spectral components.

2. A sensor according to claim 1, wherein the measuring light is also fed through the optical imaging system.

3. A sensor according to claim 1, wherein the light source is a white light source.

4. A sensor according to claim 1, wherein the light receiver is a color camera.

5. A sensor according to claim 1, wherein the light source includes a plurality of point light sources and the light receiver includes a plurality of point detectors, wherein one point detector and one point light source are associated together and are arranged in a confocal manner in relation to each other.

6. A sensor according to claim 5, wherein a grating system with a plurality of diffraction gratings is used to provide at least one of the point light sources and the point detectors.

7. A sensor according to claim 6, wherein the grating system is at least one of a one-dimensional diffraction grating line and a two-dimensional diffraction grating matrix.

8. A sensor according to claim 6, wherein the grating system also has an arrangement of microlenses.

9. A sensor according to claim 1, further comprising:
at least one further optical imaging system, arranged such that in the beam path of the illuminating light, an intermediate image of the light source is adapted to result, in an area between the further optical imaging system and the optical imaging system.

10. A sensor according to claim 9, wherein a grating system, including at least one diffraction grating, is arranged in the area of the intermediate image.

11. A sensor according to claim 10, wherein the grating system includes a rotating Nipkow disk and wherein the light receiver includes a surface detector.

12. A sensor according to claim 10, wherein the grating system includes a stationary at least one of a one-dimensional and two-dimensional diffraction grating matrix and wherein the light receiver includes at least one of a one-dimensional and two-dimensional local resolution surface detector.

13. A sensor according to claim 2, wherein the light source is a white light source.

14. A sensor according to claim 13, wherein the light receiver is a color camera.

15. A sensor according to claim 14, wherein the light source includes a plurality of point light sources and the light receiver includes a plurality of point detectors, wherein one point detector and one point light source are associated together and are arranged in a confocal manner in relation to each other.

16. A sensor according to claim 7, wherein the grating system also has an arrangement of microlenses. Abstract

17. A sensor according to claim 15, wherein a grating system with a plurality of diffraction gratings is used to provide at least one of the point light sources and the point detectors.

18. A sensor according to claim 17, wherein the grating system is at least one of a one-dimensional diffraction grating line and a two-dimensional diffraction grating matrix.

19. A sensor according to claim 17, wherein the grating system also has an arrangement of microlenses.

20. A sensor for optical distance determination based on a confocal imaging principle, comprising:
optical imaging means for directing illuminated light onto a surface of a measurement object, and for focusing different spectral components of the illuminated light at different distances from the optical imaging means due to a chromatic aberration of the optical imaging means;
means for spatially separating measuring light, reflected back at least partially from the surface, from a beam path of the illuminated light; and
means for determining the distance between the sensor and the surface from intensities of the measuring light detected for different spectral components.

21. A sensor according to claim 20, wherein the measuring light is also fed through the optical imaging system.

22. A sensor according to claim 20, further comprising means for generating the illuminated light.

23. A sensor according to claim 22, wherein the means for generating includes a white light source.

24. A sensor according to claim 20, further comprising:
means for detecting the light for different spectral components.

25. A sensor according to claim 24, wherein the means for detecting includes a color camera.

26. A sensor according to claim 22, further comprising:
means for detecting the light for different spectral components.

27. A sensor according to claim 26, wherein the means for generating the illuminated light includes a plurality of point light sources and the means for detecting the light includes a plurality of point detectors, wherein one point detector and one point light source are associated together and are arranged in a confocal manner in relation to each other.

28. A sensor according to claim 27, wherein a grating system with a plurality of diffraction gratings is used to provide at least one of the point light sources and the point detectors.

29. A sensor according to claim 28, wherein the grating system is at least one of a one-dimensional diffraction grating line and a two-dimensional diffraction grating matrix.

30. A sensor according to claim 28, wherein the grating system also has an arrangement of microlenses.

31. A sensor according to claim 20, further comprising:
at least one further optical imaging means, arranged for, in the beam path of the illuminating light, producing an intermediate image of the light, in an area between the further optical imaging means and the optical imaging means.

32. A sensor according to claim 31, wherein a grating system, including at least one diffraction grating, is arranged in the area of the intermediate image.

33. A sensor according to claim 32, wherein the grating system includes a rotating Nipkow disk and further comprising means for detecting the light, including a surface detector.

34. A sensor according to claim 32, wherein the grating system includes a stationary at least one of a one-dimensional and two-dimensional diffraction grating matrix and further comprising means for detecting the light, including at least one of a one-dimensional and two-dimensional local resolution surface detector.

35. A method of optical distance determination based on a confocal imaging principle, comprising:
directing illuminated light onto a surface of a measurement object;
focusing, using an optical imaging device of a sensor, different spectral components of the illuminated light at different distances from the optical imaging device due to a chromatic aberration of the optical imaging device;
spatially separating measuring light, reflected back at least partially from the surface, from a beam path of the illuminated light; and
determining a distance between the sensor and the surface from intensities of the measuring light detected for different spectral components.

36. A sensor for rapid optical distance determination based on a confocal imaging principle, comprising:
a light source, adapted to emit an illuminating light with different spectral components;
